(19) United States
(12) Patent Application Publication
(10) Pub. No.: US 2025/0003792 A1
(43) Pub. Date: Jan. 2, 2025

(54) OPTICAL FIBER SENSING SYSTEM, OPTICAL FIBER SENSING APPARATUS, AND OPTICAL FIBER SENSING METHOD

(71) Applicant: NEC Corporation, Tokyo (JP)

(72) Inventors: Tadayuki Iwano, Tokyo (JP); Yoshiaki Aono, Tokyo (JP); Yoshinori Kitahara, Tokyo (JP)

(73) Assignee: NEC Corporation, Tokyo (JP)

(21) Appl. No.: 18/751,478

(22) Filed: Jun. 24, 2024

(30) Foreign Application Priority Data
Jun. 30, 2023 (JP) 2023-107735

(51) Int. Cl. G01H 9/00; H04B 10/25

(52) U.S. Cl. CPC G01H 9/004; H04B 10/25

(57) ABSTRACT

The present disclosure includes: an optical fiber cable that contains a first optical fiber connected to a first point and a second point, and contains a second optical fiber; memory that stores instructions; and processor that executes the instructions to perform, in a state where the first optical fiber is connected to a communication unit at the first point side, first optical fiber sensing for sensing vibration applied to the optical fiber cable at the second point side, and perform, in a state where the second optical fiber is connected to the communication unit at the first point side, second optical fiber sensing for sensing the vibration applied to the optical fiber cable at the second point side, and determine whether the second optical fiber is connected to the first point and the second point, based on results of the first and second optical fiber sensing.

### INCORPORATION BY REFERENCE

This application is based upon and claims the benefit of priority from Japanese patent application No. 2023-107735, filed on Jun. 30, 2023, the disclosure of which is incorporated herein in its entirety by reference.

### TECHNICAL FIELD

The present disclosure relates to an optical fiber sensing system, an optical fiber sensing apparatus, and an optical fiber sensing method.

### BACKGROUND ART

Optical fiber sensing using an optical fiber as a sensor is characterized in that an optical fiber sensing apparatus (for example, a distributed fiber optic sensing (DFOS) apparatus) is able to sense vibration caused by an event occurring in the vicinity of an optical fiber and identify the event occurring in the vicinity of the optical fiber, based on the sensed vibration.

However, in the optical fiber sensing, although a distance on an optical fiber from a location of the optical fiber sensing apparatus to a location where vibration has occurred can be specified, a position (latitude/longitude) where the vibration has occurred cannot be specified, and therefore, a position (latitude/longitude) where an event has occurred cannot be specified.

For this reason, in recent years, a technique for associating a distance on an optical fiber from a location of an optical fiber sensing apparatus with position information has been proposed.

For example, International Patent Publication No. WO 2022/113252 discloses a technique of, by using a vibration generator having a function of generating vibration and a global positioning system (GPS) function, associating a distance on an optical fiber from a location of an optical fiber sensing apparatus with GPS position information, and specifying a laying route of the optical fiber, based on a result of the association.

Specifically, in the technique described in International Patent Publication No. WO 2022/113252, vibration generated by the vibration generator is sensed by optical fiber sensing, the distance on the optical fiber from the location of the optical fiber sensing apparatus to the location where the vibration is generated is specified, and the specified distance on the optical fiber and the GPS position information of the vibration generator when the vibration is generated are associated with each other.

Meanwhile, in recent years, there has been a demand to specify a laying route of a communication fiber, which is an optical fiber used in a communication line. For example, it is possible to specify the laying route of the communication fiber by the technique described in International Patent Publication No. WO 2022/113252, but for this purpose, it is necessary to perform optical fiber sensing by using the communication fiber.

However, since the communication fiber is being used in the communication line, it can only be temporarily used for optical fiber sensing during a time period in which a communication amount is small, and cannot be used for a long time. In addition, a dark fiber, which is an unused optical fiber, may be present among optical fibers contained in the same optical fiber cable as the communication fiber.

In view of the above description, in order to specify the laying route of the communication fiber by using the technique described in International Patent Publication No. WO 2022/113252, it is preferable to perform optical fiber sensing by using an optical fiber such as a dark fiber laid on the same route as the communication fiber.

Therefore, it is desired to find an optical fiber laid on the same route as the communication fiber.

### SUMMARY

Therefore, in view of the above-described issue, an example object of the present disclosure is to provide an optical fiber sensing system, an optical fiber sensing apparatus, and an optical fiber sensing method that are capable of finding an optical fiber laid on the same route as a communication fiber.

In a first example aspect, an optical fiber sensing system includes:
an optical fiber cable configured to contain a first optical fiber connected to a first point and a second point, and also contain a second optical fiber;
at least one memory configured to store an instruction group; and
at least one processor configured to execute the instruction group in such a way as to
   control a communication unit, to which the first optical fiber or the second optical fiber is connected, in such a way as to transmit pulsed light to the connected first optical fiber or second optical fiber and also receive an optical signal from the connected first optical fiber or second optical fiber,
   perform, in a state where the first optical fiber is connected to the communication unit at the first point side, first optical fiber sensing for sensing vibration applied to the optical fiber cable at the second point side, based on an optical signal received from the first optical fiber, and also perform, in a state where the second optical fiber is connected to the communication unit at the first point side, second optical fiber sensing for sensing the vibration applied to the optical fiber cable at the second point side, based on an optical signal received from the second optical fiber, and
   determine whether the second optical fiber is connected to the first point and the second point, based on a result of the first optical fiber sensing and a result of the second optical fiber sensing.

In a second example aspect, an optical fiber sensing apparatus includes:
at least one memory configured to store an instruction group; and
at least one processor configured to execute the instruction group in such a way as to
   control a communication unit, to which a first optical fiber connected to a first point and a second point, or a second optical fiber contained in the same optical fiber cable as the first optical fiber is connected, in such a way as to transmit pulsed light to the connected first optical fiber or second optical fiber and also receive an optical signal from the connected first optical fiber or second optical fiber,
   perform, in a state where the first optical fiber is connected to the communication unit at the first point side, first optical fiber sensing for sensing vibration applied to the optical fiber cable at the second point side, based on an optical signal received from the first optical fiber, and also perform, in a state where the second optical fiber is connected to the communication unit at the first point side, second optical fiber sensing for sensing the vibration applied to the optical fiber cable at the second point side, based on an optical signal received from the second optical fiber, and
   determine whether the second optical fiber is connected to the first point and the second point, based on a result of the first optical fiber sensing and a result of the second optical fiber sensing.

In a third example aspect, an optical fiber sensing method is a method performed by an optical fiber sensing apparatus, and includes:
a communication step of transmitting pulsed light to a first optical fiber connected to a first point and a second point, or to a second optical fiber contained in the same optical fiber cable as the first optical fiber, and also receiving an optical signal from the first optical fiber or the second optical fiber;
a sensing step of performing, in a state where the first optical fiber is connected to the optical fiber sensing apparatus at the first point side, first optical fiber sensing for sensing vibration applied to the optical fiber cable at the second point side, based on an optical signal received from the first optical fiber, and also performing, in a state where the second optical fiber is connected to the optical fiber sensing apparatus at the first point side, second optical fiber sensing for sensing the vibration applied to the optical fiber cable at the second point side, based on an optical signal received from the second optical fiber; and
a determination step of determining whether the second optical fiber is connected to the first point and the second point, based on a result of the first optical fiber sensing and a result of the second optical fiber sensing.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a configuration example of an optical fiber sensing system according to a first example embodiment;

FIG. 2 is a diagram for describing an example of a schematic operation of an optical fiber sensing apparatus according to the first example embodiment;

FIG. 3 is a diagram for describing an example of a schematic operation of the optical fiber sensing apparatus according to the first example embodiment;

FIG. 4 is a diagram for describing an example of a schematic operation of the optical fiber sensing apparatus according to the first example embodiment;

FIG. 5 is a flow diagram for describing an example of a flow of a schematic operation of the optical fiber sensing apparatus according to the first example embodiment;

FIG. 6 is a diagram illustrating a configuration example of an optical fiber sensing system according to a second example embodiment;

FIG. 7 is a diagram for describing an example of a schematic operation of the optical fiber sensing apparatus according to the second example embodiment;

FIG. 8 is a diagram illustrating a configuration example of an optical fiber sensing system according to a third example embodiment;

FIG. 9 is a diagram illustrating an example of a schematic operation of an optical fiber sensing apparatus according to the third example embodiment;

FIG. 10 is a diagram for describing an example of a schematic operation of the optical fiber sensing apparatus according to the third example embodiment;

FIG. 11 is a diagram for describing an example of a schematic operation of the optical fiber sensing apparatus according to the third example embodiment;

FIG. 12 is a diagram illustrating a configuration example of an optical fiber sensing system according to a fourth example embodiment;

FIG. 13 is a diagram for describing an example of a schematic operation of an optical fiber sensing apparatus according to the fourth example embodiment;

FIG. 14 is a diagram for describing an example of a schematic operation of the optical fiber sensing apparatus according to the fourth example embodiment;

FIG. 15 is a diagram for describing an example of a schematic operation of the optical fiber sensing apparatus according to the fourth example embodiment; and

FIG. 16 is a block diagram illustrating an example of a hardware configuration of a computer that implements the optical fiber sensing apparatus according to each of the example embodiments.

### EXAMPLE EMBODIMENT

Hereinafter, example embodiments of the present disclosure are described with reference to the drawings. Note that the following description and the drawings are omitted and simplified as appropriate for clarity of description. In the following drawings, the same element is denoted by the same reference sign, and redundant descriptions are omitted as necessary.

### First Example Embodiment

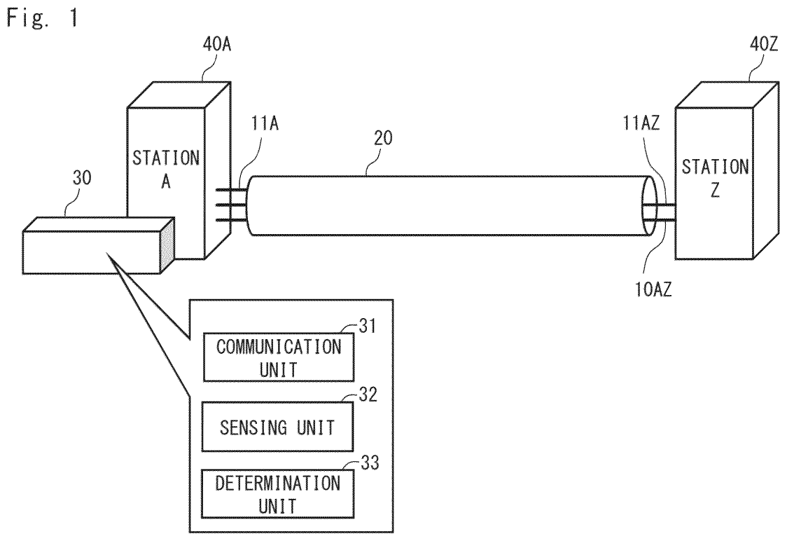

First, a configuration example of an optical fiber sensing system according to a first example embodiment is described with reference to FIG. 1.

As illustrated in FIG. 1, the optical fiber sensing system according to the first example embodiment includes an optical fiber cable 20 and an optical fiber sensing apparatus 30.

In the example of FIG. 1, the optical fiber cable 20 contains a communication fiber 10AZ (first optical fiber) which is an optical fiber being used in a communication line. The communication fiber 10AZ is connected to a communication station 40A and a communication station 40Z.

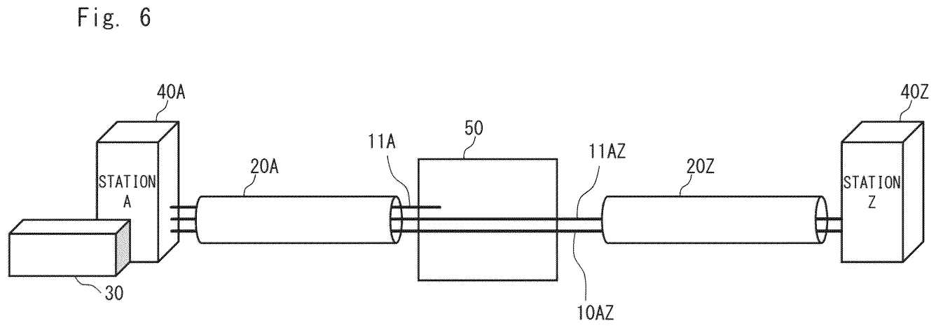

The optical fiber cable 20 also contains dark fibers 11AZ and 11A (second optical fibers), which are unused optical fibers. Similarly to the communication fiber 10AZ, the dark fiber 11AZ is connected to the communication station 40A and the communication station 40Z. Meanwhile, the dark fiber 11A is connected to the communication station 40A, but is disconnected between the communication station 40A and the communication station 40Z, and is not connected to the communication station 40Z. Hereinafter, when it is not specified between the dark fibers 11AZ and 11A, it is simply referred to as [dark fiber 11] as appropriate. In the example of FIG. 1, the number of optical fibers contained in the optical fiber cable 20 is three, among which the number of dark fibers 11 is two, but this is merely an example, and the number of optical fibers contained in the optical fiber cable 20 and the number of dark fibers 11 among the optical fibers may be any number (hereinafter the same applies to FIGS. 6, 8, and 12).

The optical fiber sensing apparatus 30 includes a communication unit 31, a sensing unit 32, and a determination unit 33. The optical fiber sensing apparatus 30 is achieved by, for example, a DFOS device such as a distributed vibration sensing (DVS) device or a distributed acoustic sensing (DAS) device. In the example of FIG. 1, the optical fiber sensing apparatus 30 is disposed in the communication station 40A. However, the optical fiber sensing apparatus 30 may be moved by a user, and may be arranged at any place.

The communication fiber 10AZ or one of the dark fiber 11 is connected to the communication unit 30 on the communication station 40A side. The communication unit 31 transmits pulsed light to the connected communication fiber 10AZ or dark fiber 11. Then, as the pulsed light is transmitted through the communication fiber 10AZ or the dark fiber 11, backscattered light is generated. The communication unit 31 receives the backscattered light as an optical signal from the connected communication fiber 10AZ or dark fiber 11.

In the first example embodiment, first, the communication fiber 10AZ is connected to the communication unit 31 of the optical fiber sensing apparatus 30 on the communication station 40A side. In a state where the communication fiber 10AZ is connected to the communication unit 31 of the optical fiber sensing apparatus 30, the user applies vibration to the optical fiber cable 20 on the communication station 40Z side. The method for applying vibration to the optical fiber cable 20 may be any method, such as tapping with a rod. In such a state, the sensing unit 32 performs first optical fiber sensing for sensing the vibration applied to the optical fiber cable 20 on the communication station 40Z side, based on the optical signal received from the communication fiber 10AZ.

Next, dark fibers 11 are sequentially connected to the communication unit 31 of the optical fiber sensing apparatus 30 on the communication station 40A side. Each time the connection is established, in a state where the dark fiber 11 is connected to the communication unit 31 of the optical fiber sensing apparatus 30, the user applies vibration to the optical fiber cable 20 on the communication station 40Z side, and the sensing unit 32 performs second optical fiber sensing for sensing the vibration applied to the optical fiber cable 20 on the communication station 40Z side, based on the optical signal received from the dark fiber 11. Further, the determination unit 33 determines whether the dark fiber 11 on which the second optical fiber sensing is performed is connected to the communication station 40A and the communication station 40Z, based on a result of the first optical fiber sensing and a result of the second optical fiber sensing.

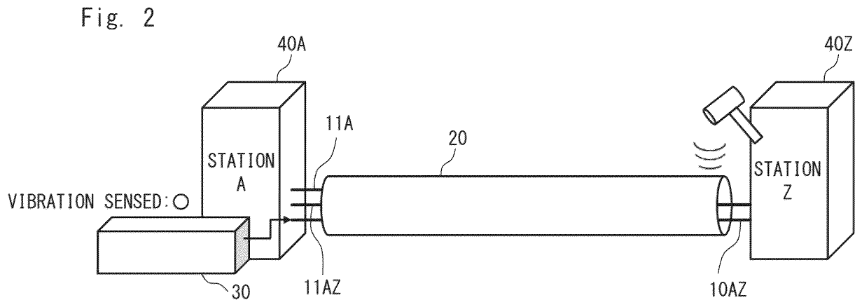

Next, operation of the optical fiber sensing apparatus 30 according to the first example embodiment is described in more detail below with reference to FIGS. 2 to 4.

First, as illustrated in FIG. 2, the communication fiber 10AZ is connected to the communication unit 31 of the optical fiber sensing apparatus 30 on the communication station 40A side, and the first optical fiber sensing is performed.

Hereinafter, the above-described operation is described in detail.

In a state where the communication fiber 10AZ is connected to the communication unit 31 of the optical fiber sensing apparatus 30 on the communication station 40A side, the communication unit 31 transmits pulsed light to the communication fiber 10AZ. Further, the communication unit 31 receives backscattered light from the communication fiber 10AZ as an optical signal. Herein, since the communication fiber 10AZ is being used in a communication line, it cannot be used for a long time. Therefore, it is assumed that the above-described operation is performed by temporarily using the communication fiber 10AZ in a time period in which the communication amount is small or the like. At this time, the above-described operation may be performed while the communication fiber 10AZ temporarily stops the service of the communication line. Alternatively, the above operation may be performed while the communication fiber 10AZ is continuing the service of the communication line. However, while the service of the communication line is continuing, a signal for the communication line is also transmitted to the communication fiber 10AZ. Therefore, during the continuation of the service of the communication line, the communication unit 31 may transmit the pulsed light to the communication fiber 10AZ by using a method such as wavelength-multiplexing the pulsed light to the signal for the communication line.

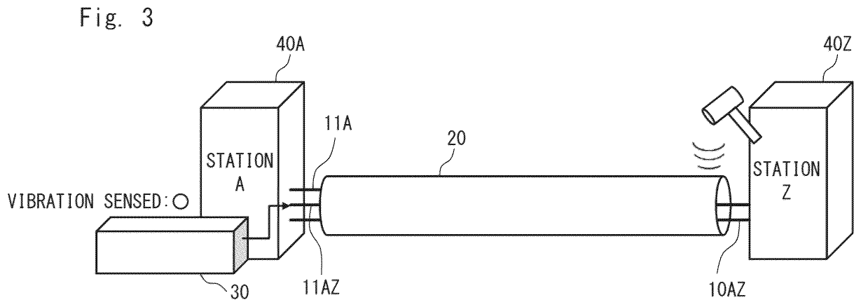

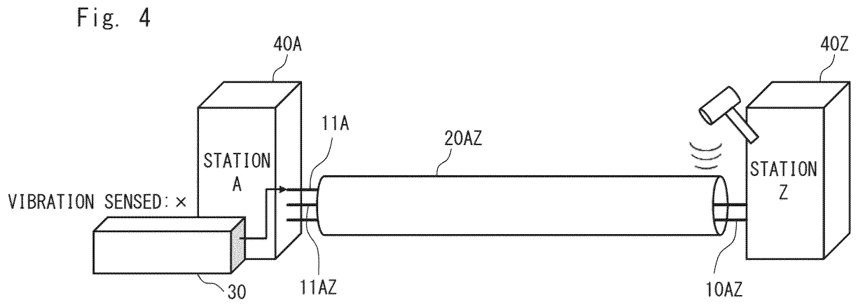

In such a state, the user applies vibration to the optical fiber cable 20 on the communication station 40Z side. Therefore, in the example of FIG. 2, the communication station 40A is the first point, and the communication station 40Z is the second point (hereinafter, the same applies to FIGS. 3 and 4).

In such a state, the sensing unit 32 performs the first optical fiber sensing for sensing the vibration applied to the optical fiber cable 20 on the communication station 40Z side, based on the optical signal received from the communication fiber 10AZ.

At this time, since the communication fiber 10AZ extends to the communication station 40Z, the vibration applied to the optical fiber cable 20 is propagated to the communication fiber 10AZ. As a result, a characteristic (for example, a wavelength) of the optical signal transmitted through the communication fiber 10AZ changes.

Therefore, the sensing unit 32 is able to sense the vibration applied to the optical fiber cable 20 on the communication station 40Z side, based on the optical signal received from the communication fiber 10AZ.

Further, since the vibration applied to the optical fiber cable 20 has been sensed, the sensing unit 32 specifies the distance on the communication fiber 10AZ from the location of the optical fiber sensing apparatus 30 (the communication unit 31) to the location where the vibration is generated (that is, the location where the characteristic of the optical signal has changed). For example, the sensing unit 32 specifies the above-described distance, based on a time difference between a time at which the pulsed light is transmitted to the communication fiber 10AZ by the communication unit 31 and a time at which the communication unit 31 received, from the communication fiber 10AZ, the optical signal the characteristics of which have changed.

Next, as illustrated in FIGS. 3 and 4, the dark fibers 11 contained in the same optical fiber cable 20 as the communication fiber 10AZ are sequentially connected to the communication unit 31 of the optical fiber sensing apparatus 30 on the communication station 40A side, and each time the connection is established, the second optical fiber sensing is performed, and determination is made whether the connected dark fiber 11 is connected to the communication station 40A and the communication station 40Z.

Hereinafter, the above-described operation is described in detail. Herein, it is assumed that the dark fiber 11AZ is first connected to the communication unit 31 of the optical fiber sensing apparatus 30, and then the dark fiber 11A is connected to the communication unit 31.

First, an operation being performed in a state where the dark fiber 11AZ is connected to the communication unit 31 of the optical fiber sensing apparatus 30 on the communication station 40A side is described with reference to FIG. 3.

As illustrated in FIG. 3, in a state where the dark fiber 11AZ is connected to the communication unit 31 of the optical fiber sensing apparatus 30 on the communication station 40A side, the communication unit 31 transmits pulsed light to the dark fiber 11AZ and receives backscattered light from the dark fiber 11AZ as an optical signal. In such a state, the user applies vibration to the optical fiber cable 20 on the communication station 40Z side.

In such a state, the sensing unit 32 performs the second optical fiber sensing for sensing the vibration applied to the optical fiber cable 20 on the communication station 40Z side, based on the optical signal received from the dark fiber 11AZ.

At this time, the dark fiber 11AZ extends to the communication station 40Z. Therefore, the sensing unit 32 is able to sense the vibration applied to the optical fiber cable 20 on the communication station 40Z side, based on the optical signal received from the dark fiber 11AZ.

In addition, since the vibration applied to the optical fiber cable 20 has been sensed, the sensing unit 32 specifies the distance on the dark fiber 11AZ from the location of the optical fiber sensing apparatus 30 (the communication unit 31) to the location where the vibration is generated.

Herein, in either of the first optical fiber sensing performed in a state where the communication fiber 10AZ is connected to the communication unit 31 of the optical fiber sensing apparatus 30 on the communication station 40A side, and the second optical fiber sensing performed in a state where the dark fiber 11AZ is connected to the communication unit 31 of the optical fiber sensing apparatus 30 on the communication station 40A side, the vibration applied to the optical fiber cable 20 on the communication station 40Z side has been sensed.

Therefore, the determination unit 33 calculates a difference between the distance on the communication fiber 10AZ specified by the first optical fiber sensing and the distance on the dark fiber 11AZ specified by the second optical fiber sensing, and determines whether the calculated difference is within a predetermined range. Herein, it is assumed that the difference is within the predetermined range, and the determination unit 33 determines that the dark fiber 11AZ is connected to the communication station 40A and the communication station 40Z.

Next, an operation performed in a state where the dark fiber 11A is connected to the communication unit 31 of the optical fiber sensing apparatus 30 on the communication station 40A side is described with reference to FIG. 4.

As illustrated in FIG. 4, in a state where the dark fiber 11A is connected to the communication unit 31 of the optical fiber sensing apparatus 30 on the communication station 40A side, the communication unit 31 transmits pulsed light to the dark fiber 11A and receives backscattered light from the dark fiber 11A as an optical signal. In such a state, the user applies vibration to the optical fiber cable 20 on the communication station 40Z side.

In such a state, the sensing unit 32 performs second optical fiber sensing for sensing vibration applied to the optical fiber cable 20 on the communication station 40Z side, based on the optical signal received from the dark fiber 11A.

At this time, the dark fiber 11A is disconnected between the communication station 40A and the communication station 40Z, and does not extend to the communication station 40Z. Therefore, the vibration applied to the optical fiber cable 20 on the communication station 40Z side is not propagated to the dark fiber 11A, and the characteristics of the optical signal transmitted through the dark fiber 11A are not changed.

Therefore, the sensing unit 32 cannot sense the vibration applied to the optical fiber cable 20.

Therefore, the determination unit 33 determines that the dark fiber 11A is disconnected between the communication station 40A and the communication station 40Z.

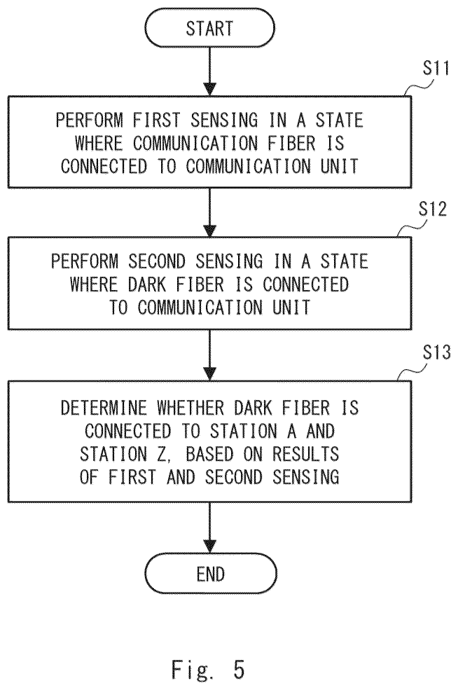

Next, an example of a flow of a schematic operation of the optical fiber sensing apparatus 30 according to the first example embodiment is described below with reference to FIG. 5.

As illustrated in FIG. 5, first, in a state where the communication fiber 10AZ is connected to the communication unit 31 of the optical fiber sensing apparatus 30 on the communication station 40A side, the sensing unit 32 performs the first optical fiber sensing for sensing the vibration applied to the optical fiber cable 20 on the communication station 40Z side, based on the optical signal received from the communication fiber 10AZ (step S11).

Specifically, in the first optical fiber sensing, the vibration applied to the optical fiber cable 20 on the communication station 40Z side is sensed, and when the vibration has been sensed, the distance on the communication fiber 10AZ from the location of the optical fiber sensing apparatus 30 (communication unit 31) to the location where the vibration is generated is specified.

Next, in a state where the dark fiber 11 contained in the same optical fiber cable 20 as the communication fiber 10AZ is connected to the communication unit 31 of the optical fiber sensing apparatus 30 on the communication station 40A side, the sensing unit 32 performs the second optical fiber sensing for sensing the vibration applied to the optical fiber cable 20 on the communication station 40Z side, based on the optical signal received from the dark fiber 11 (step S12).

Specifically, in the second optical fiber sensing, the vibration applied to the optical fiber cable 20 on the communication station 40Z side is sensed, and when the vibration has been sensed, the distance on the dark fiber 11 from the location of the optical fiber sensing apparatus 30 (communication unit 31) to the location where the vibration is generated is specified.

Thereafter, the determination unit 33 determines whether the dark fiber 11 is connected to the communication station 40A and the communication station 40Z, based on the result of the first optical fiber sensing in step S11 and the result of the second optical fiber sensing in step S12 (step S13).

Specifically, when vibration is sensed by the first optical fiber sensing and the second optical fiber sensing, the determination unit 33 calculates a difference between the distance on the communication fiber 10AZ, specified by the first optical fiber sensing, and the distance on the dark fiber 11, specified by the second optical fiber sensing. Then, when vibration has been sensed by the first optical fiber sensing and the second optical fiber sensing and the difference is within a predetermined range, the determination unit 33 determines that the dark fiber 11 is connected to the communication station 40A and the communication station 40Z. Meanwhile, when the vibration cannot be sensed by the second optical fiber sensing, the determination unit 33 determines that the dark fiber 11 is disconnected between the communication station 40A and the communication station 40Z.

Note that, in the example of FIG. 1, two dark fibers 11AZ and 11A are contained in the same optical fiber cable 20 as the communication fiber 10AZ. Therefore, in the example of FIG. 5, steps S12 and S13 may be performed for each of the dark fibers 11AZ and 11A.

As described above, according to the first example embodiment, first, in a state where the communication fiber 10AZ is connected to the communication unit 31 of the optical fiber sensing apparatus 30 on the communication station 40A side, the sensing unit 32 performs the first optical fiber sensing for sensing the vibration applied to the optical fiber cable 20 on the communication station 40Z side, based on the optical signal received from the communication fiber 10AZ. Next, in a state where the dark fiber 11 is connected to the communication unit 31 of the optical fiber sensing apparatus 30 on the communication station 40A side, the sensing unit 32 performs the second optical fiber sensing for sensing the vibration applied to the optical fiber cable 20 on the communication station 40Z side, based on the optical signal received from the dark fiber 11. Thereafter, the determination unit 33 determines whether the dark fiber 11 is connected to the communication station 40A and the communication station 40Z, based on the result of the first optical fiber sensing and the result of the second optical fiber sensing. Thus, the dark fiber 11AZ laid on the same route as the communication fiber 10AZ being connected to both the communication station 40A and the communication station 40Z can be found. Therefore, by performing optical fiber sensing by using the dark fiber 11AZ, it is possible to specify the laying route of the communication fiber 10AZ.

### Second Example Embodiment

First, a configuration example of an optical fiber sensing system according to the second example embodiment is described with reference to FIG. 6.

As illustrated in FIG. 6, the optical fiber sensing system according to the second example embodiment differs from the above-described configuration of FIG. 1 of the first example embodiment in that a closure 50 is interposed between a communication station 40A and a communication station 40Z.

In the example of FIG. 6, an optical fiber cable 20A is interposed between the communication station 40A and the closure 50, and contains a communication fiber 10AZ (first optical fiber). The communication fiber 10AZ is connected to the communication station 40A and the communication station 40Z via the closure 50.

The optical fiber cable 20A also contains dark fibers 11AZ and 11A (second optical fibers). Similarly to the communication fiber 10AZ, the dark fiber 11AZ is connected to the communication station 40A and the communication station 40Z via the closure 50. Meanwhile, the dark fiber 11A is connected to the communication station 40A and the closure 50, but does not extend to the communication station 40Z.

An optical fiber cable 20Z is interposed between the closure 50 and the communication station 40Z, and contains the above-described communication fiber 10AZ and dark fiber 11AZ.

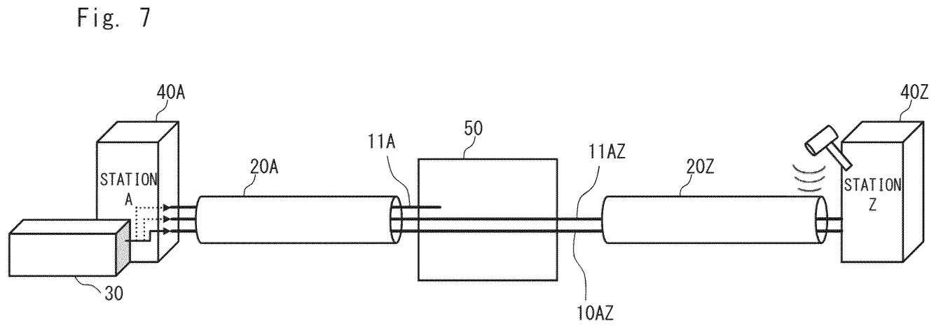

Next, operation of an optical fiber sensing apparatus 30 according to the second example embodiment is described below with reference to FIG. 7.

As illustrated in FIG. 7, first, the communication fiber 10AZ is connected to a communication unit 31 of the optical fiber sensing apparatus 30 on the communication station 40A side, and first optical fiber sensing for sensing vibration applied by the user to the optical fiber cable 20Z on the communication station 40Z side is performed. Next, the dark fibers 11AZ and 11A contained in the same optical fiber cable 20A as the communication fiber 10AZ are connected one by one in any order to the communication unit 31 of the optical fiber sensing apparatus 30 on the communication station 40A side, and each time the connection is established, second optical fiber sensing for sensing the vibration applied by the user to the optical fiber cable 20Z on the communication station 40Z side is performed. Further, each time the connection is established, determination is made whether the connected dark fibers 11AZ and 11A are connected to the communication station 40A and the communication station 40Z. Therefore, in the example of FIG. 7, the communication station 40A is the first point, and the communication station 40Z is the second point. In the example of FIG. 7, the specific operations of the above-described first and second optical fiber sensing and the above-described determination are similar to those in the above-described first example embodiment, and thus description thereof is omitted.

As a result of the operation of FIG. 7, a determination unit 33 determines that the dark fiber 11AZ is connected to the communication station 40A and the communication station 40Z. Meanwhile, the determination unit 33 determines that the dark fiber 11A is disconnected between the communication station 40A and the communication station 40Z.

As described above, according to the second example embodiment, even when the closure 50 is interposed between the communication station 40A and the communication station 40Z, the dark fiber 11AZ laid on the same route as the communication fiber 10AZ being connected to both the communication station 40A and the communication station 40Z can be found. Therefore, by performing optical fiber sensing by using the dark fiber 11AZ, it is possible to specify the laying route of the communication fiber 10AZ.

### Third Example Embodiment

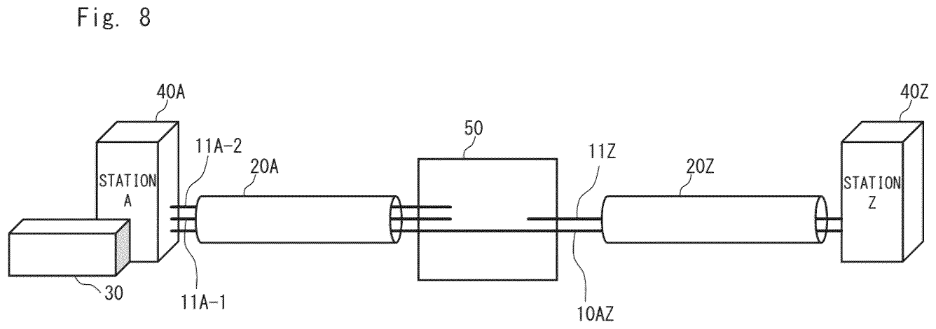

First, a configuration example of an optical fiber sensing system according to the third example embodiment is described with reference to FIG. 8.

As illustrated in FIG. 8, the optical fiber sensing system according to the third example embodiment differs from the configuration of FIG. 6 of the second example embodiment described above in that a dark fiber connected to each of communication stations 40A and 40Z extends only to a closure 50.

In the example of FIG. 8, an optical fiber cable 20A is interposed between the communication station 40A and the closure 50, and contains a communication fiber 10AZ (first optical fiber). The communication fiber 10AZ is connected to the communication station 40A and the communication station 40Z via the closure 50.

The optical fiber cable 20A also contains dark fibers 11A-1 and 11A-2 (second optical fibers). The dark fibers 11A-1 and 11A-2 are connected to the communication station 40A and the closure 50, but do not extend to the communication station 40Z.

An optical fiber cable 20Z is interposed between the closure 50 and the communication station 40Z, and contains the above-described communication fiber 10AZ.

The optical fiber cable 20Z also contains a dark fiber 11Z (second optical fiber). The dark fiber 11Z is connected to the closure 50 and the communication station 40Z, but does not extend to the communication station 40A.

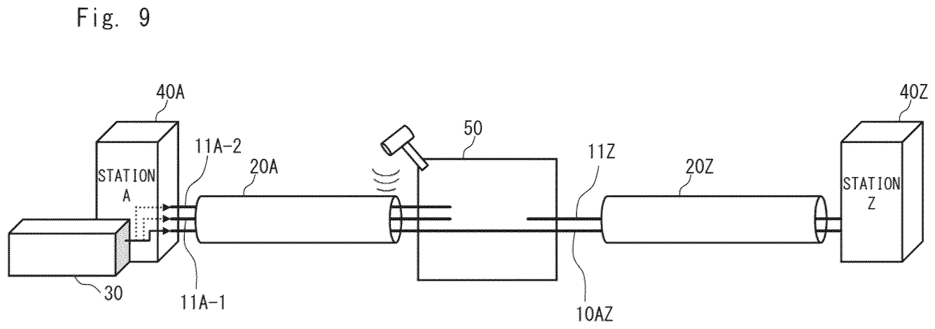

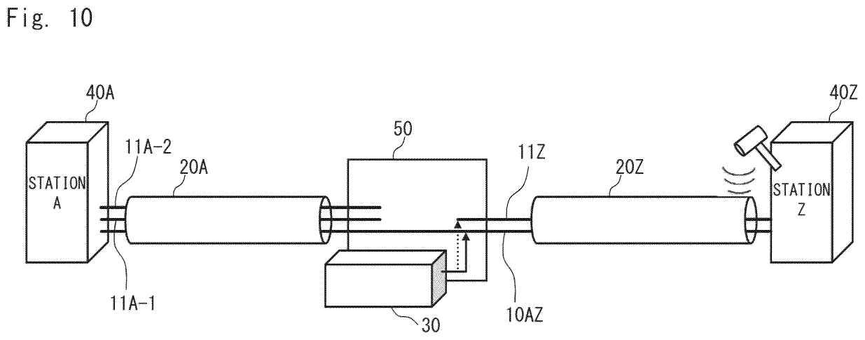

Next, operation of an optical fiber sensing apparatus 30 according to the third example embodiment is described with reference to FIGS. 9 to 11. Note that the following operations performed in FIGS. 9 and 10 are not limited to the order in which the operations are performed.

As illustrated in FIG. 9, first, the communication fiber 10AZ is connected to a communication unit 31 of the optical fiber sensing apparatus 30 on the communication station 40A side, and first optical fiber sensing for sensing vibration applied by a user to the optical fiber cable 20A on the closure 50 side is performed. Next, the dark fibers 11A-1 and 11A-2 contained in the same optical fiber cable 20A as the communication fiber 10AZ are connected one by one in any order to the communication unit 31 of the optical fiber sensing apparatus 30 on the communication station 40A side, and each time the connection is established, second optical fiber sensing for sensing the vibration applied by the user to the optical fiber cable 20A on the closure 50 side is performed. Further, each time the connection is established, determination is made whether the connected dark fibers 11A-1 and 11A-2 are connected to the communication station 40A and the closure 50. Therefore, in the example of FIG. 9, the communication station 40A is the first point and the closure 50 is the second point. In the example of FIG. 9, the specific operations of the above-described first and second optical fiber sensing and the above-described determination are similar to those in the above-described first example embodiment, and thus description thereof is omitted.

As a result of the operation of FIG. 9, a determination unit 33 determines that the dark fibers 11A-1 and 11A-2 are connected to the communication station 40A and the closure 50.

Further, as illustrated in FIG. 10, first, the communication fiber 10AZ is connected to the communication unit 31 of the optical fiber sensing apparatus 30 on the closure 50 side, and the first optical fiber sensing for sensing the vibration applied by the user to the optical fiber cable 20Z on the communication station 40Z side is performed. Next, the dark fiber 11Z contained in the same optical fiber cable 20Z as the communication fiber 10AZ is connected to the communication unit 31 of the optical fiber sensing apparatus 30 on the closure 50 side, and the second optical fiber sensing for sensing the vibration applied by the user to the optical fiber cable 20Z on the communication station 40Z side is performed. In addition, it is determined whether the connected dark fiber 11Z is connected to the closure 50 and the communication station 40Z. Therefore, in the example of FIG. 10, the closure 50 is the first point, and the communication station 40Z is the second point. Conversely, however, the closure 50 may be the second point and the communication station 40Z may be the first point. That is, the communication fiber 10AZ and the dark fiber 11Z may be connected to the communication unit 31 of the optical fiber sensing apparatus 30 on the communication station 40Z side, and vibration may be applied to the optical fiber cable 20Z on the closure 50 side. In FIG. 10, the specific operations of the above-described first and second optical fiber sensing and the above-described determination are the similar to those in the above-described first example embodiment, and thus description thereof is omitted.

As a result of the operation of FIG. 10, the determination unit 33 determines that the dark fiber 11Z is connected to the closure 50 and the communication station 40Z.

As described above, the determination unit 33 determines that the dark fibers 11A-1 and 11A-2 are connected to the communication station 40A and the closure 50, and determines that the dark fiber 11Z is connected to the closure 50 and the communication station 40Z.

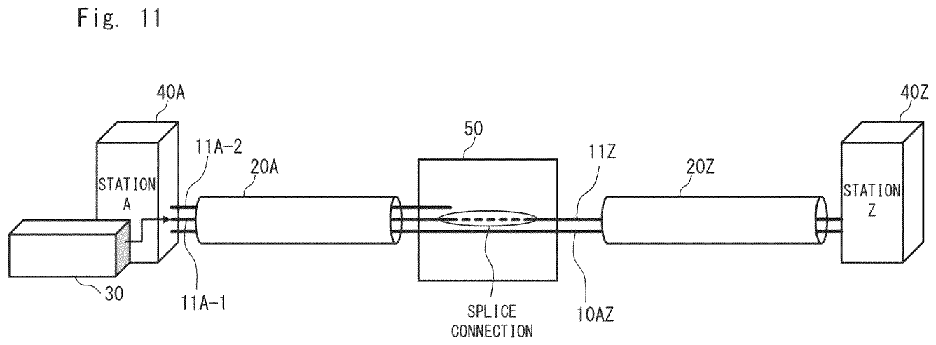

Therefore, when the dark fiber 11A-1 or 11A-2 and the dark fiber 11Z are performed splice connection at the closure 50, an optical fiber thus acquired is connected to the communication station 40A and the communication station 40Z, similarly to the communication fiber 10AZ. Therefore, in a case of specifying the laying route of the communication fiber 10AZ, optical fiber sensing may be performed by using an optical fiber acquired by performing splice connection the dark fiber 11A-1 or 11A-2 and the dark fiber 11Z to each other. FIG. 11 illustrates an example in which the dark fiber 11A-1 and the dark fiber 11Z are performed splice connection at the closure 50.

As described above, according to the third example embodiment, even when the dark fiber connected to each of the communication stations 40A and 40Z extends only to the closure 50, the dark fibers 11A-1 and 11A-2 being connected to both the communication station 40A and the closure 50 can be found. Further, the dark fiber 11Z being connected to the closure 50 and the communication station 40Z can be found. Therefore, when the dark fiber 11A-1 or 11A-2 and the dark fiber 11Z are performed splice connection at the closure 50, an optical fiber laid on the same route as the communication fiber 10AZ being connected to the communication station 40A and the communication station 40Z can be acquired. Therefore, by performing optical fiber sensing by using the acquired optical fiber, it is possible to specify the laying route of the communication fiber 10AZ.

### Fourth Example Embodiment

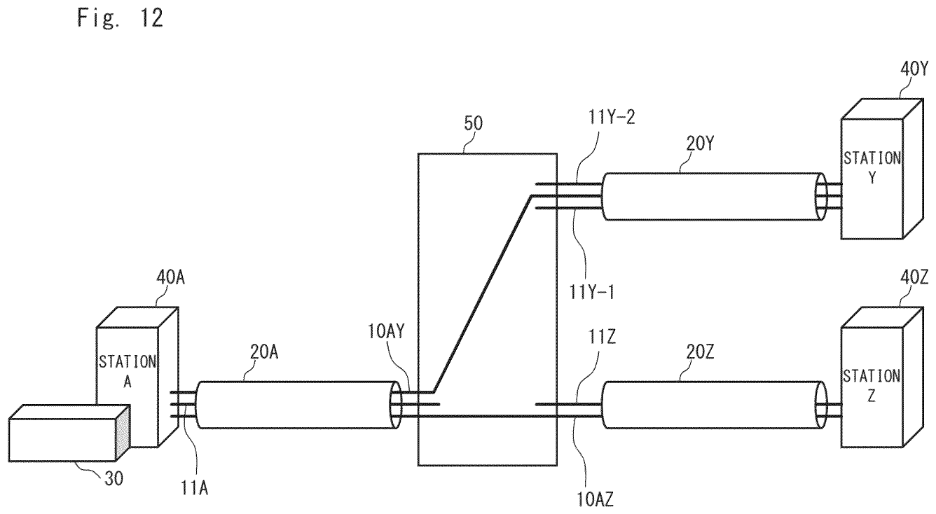

First, a configuration example of an optical fiber sensing system according to the fourth example embodiment is described with reference to FIG. 12.

As illustrated in FIG. 12, the optical fiber sensing system according to the fourth example embodiment differs from the configuration of FIG. 8 of the third example embodiment described above in that a communication station 40A is connected to communication stations 40Y and 40Z in a one-to-many manner.

In the example of FIG. 12, an optical fiber cable 20A is interposed between the communication station 40A and a closure 50, and contains communication fibers 10AY and 10AZ (first optical fiber). The communication fiber 10AY is connected to the communication station 40A and the communication station 40Y via the closure 50. The communication fiber 10AZ is connected to the communication station 40A and the communication station 40Z via the closure 50.

The optical fiber cable 20A also contains a dark fiber 11A (second optical fiber). The dark fiber 11A is connected to the communication station 40A and the closure 50, but does not extend to the communication stations 40Y and 40Z.

An optical fiber cable 20Y is interposed between the closure 50 and the communication station 40Y, and contains the above-described communication fiber 10AY.

The optical fiber cable 20Y also contains dark fibers 11Y-1 and 11Y-2 (second optical fibers). The dark fibers 11Y-1 and 11Y-2 are connected to the closure 50 and the communication station 40Y, but do not extend to the communication station 40A.

An optical fiber cable 20Z is interposed between the closure 50 and the communication station 40Z, and contains the above-described communication fiber 10AZ.

The optical fiber cable 20Z also contains a dark fiber 11Z (second optical fiber). The dark fiber 11Z is connected to the closure 50 and the communication station 40Z, but does not extend to the communication station 40A.

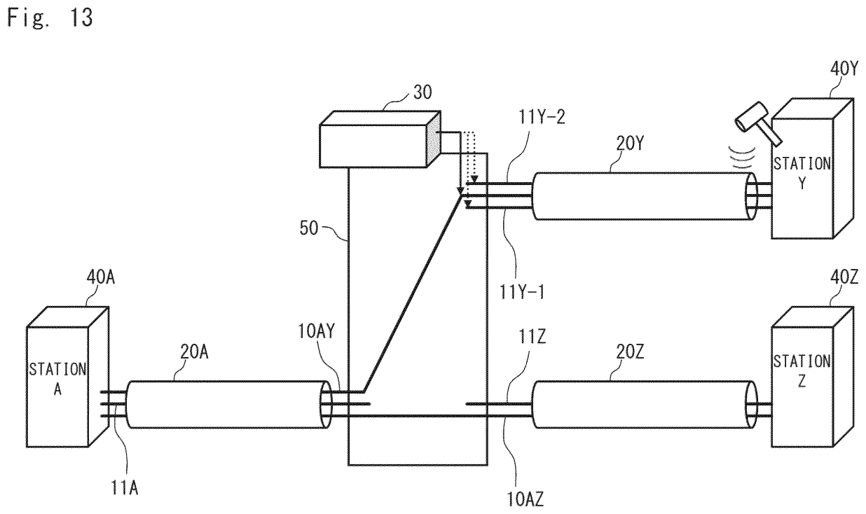

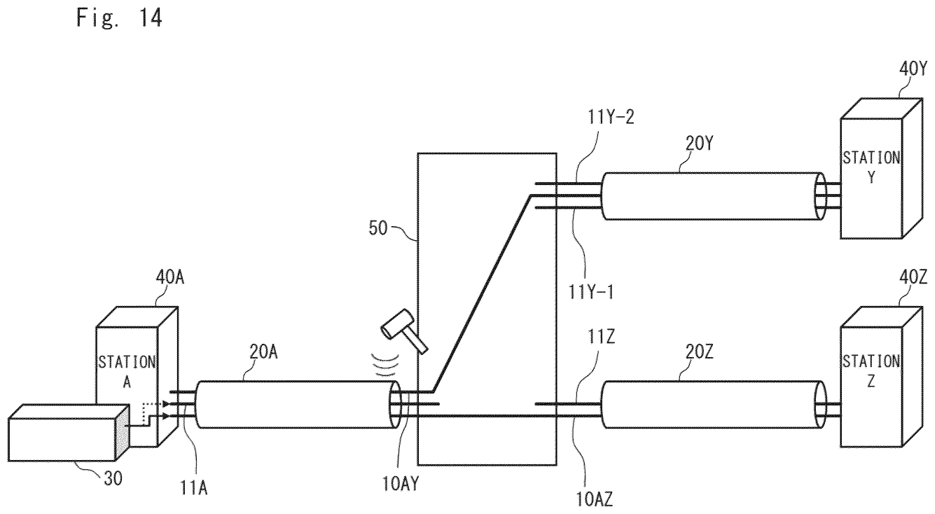

Next, operation of an optical fiber sensing apparatus 30 according to the fourth example embodiment is described below with reference to FIGS. 13 to 15. In the fourth example embodiment, the operations of FIG. 10 described above are also performed in addition to operations performed in FIGS. 13 and 14 described below. The operations performed in FIGS. 13, 14, and 10 are not limited to the order in which the operations are performed.

As illustrated in FIG. 13, first, the communication fiber 10AY is connected to a communication unit 31 of the optical fiber sensing apparatus 30 on the closure 50 side, and first optical fiber sensing for sensing vibration applied by a user to the optical fiber cable 20Y on the communication station 40Y side is performed. Next, the dark fibers 11Y-1 and 11Y-2 contained in the same optical fiber cable 20Y as the communication fiber 10AY are connected one by one in any order to the communication unit 31 of the optical fiber sensing apparatus 30 on the closure 50 side, and each time the connection is established, second optical fiber sensing for sensing the vibration applied by the user to the optical fiber cable 20Y on the communication station 40Y side is performed. Further, each time the connection is established, determination is made whether the connected dark fibers 11Y-1 and 11Y-2 are connected to the closure 50 and the communication station 40Y. Therefore, in the example of FIG. 13, the closure 50 is the first point, and the communication station 40Y is the second point. Conversely, however, the closure 50 may be the second point, and the communication station 40Y may be the first point. That is, the communication fiber 10AZ and the dark fibers 11Y-1 and 11Y-2 may be connected to the communication unit 31 of the optical fiber sensing apparatus 30 on the communication station 40Y side, and vibration may be applied to the optical fiber cable 20Y on the closure 50 side. In FIG. 13, the specific operations of the above-described first and second optical fiber sensing and above-described determination are similar to those in the above-described first example embodiment, and thus description thereof is omitted.

As a result of the operation of FIG. 13, a determination unit 33 determines that the dark fibers 11Y-1 and 11Y-2 are connected to the closure 50 and the communication station 40Y.

Further, as illustrated in FIG. 14, first, the communication fiber 10AZ is connected to the communication unit 31 of the optical fiber sensing apparatus 30 on the communication station 40A side, and the first optical fiber sensing for sensing the vibration applied by the user to the optical fiber cable 20A on the closure 50 side is performed. However, the first optical fiber sensing may be performed by connecting the communication fiber 10AY to the communication unit 31 of the optical fiber sensing apparatus 30 on the communication station 40A side. Next, the dark fiber 11A contained in the same optical fiber cable 20A as the communication fiber 10AZ is connected to the communication unit 31 of the optical fiber sensing apparatus 30 on the communication station 40A side, and the second optical fiber sensing for sensing the vibration applied by the user to the optical fiber cable 20A on the closure 50 side is performed. In addition, it is determined whether the connected dark fiber 11A is connected to the communication station 40A and the closure 50. Therefore, in the example of FIG. 14, the communication station 40A is the first point and the closure 50 is the second point. In the example of FIG. 14, the specific operations of the above-described first and second optical fiber sensing and the above-described determination are similar to those in the above-described first example embodiment, and thus description thereof is omitted.

As a result of the operation of FIG. 14, the determination unit 33 determines that the dark fiber 11A is connected to the communication station 40A and the closure 50.

As a result of the operation of FIG. 10 described above, the determination unit 33 determines that the dark fiber 11Z is connected to the closure 50 and the communication station 40Z.

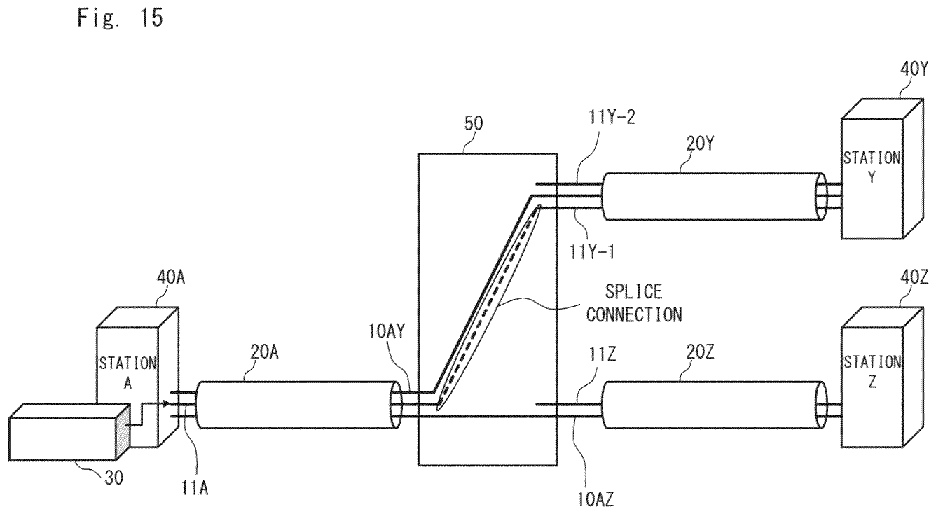

Therefore, when the dark fiber 11A and the dark fiber 11Y-1 or 11Y-2 are performed splice connection at the closure 50, an optical fiber acquired thereby is connected to the communication station 40A and the communication station 40Y in a similar manner to the communication fiber 10AY. Therefore, in a case of specifying the laying route of the communication fiber 10AY, optical fiber sensing may be performed by using an optical fiber acquired by performing splice connection the dark fiber 11A and the dark fiber 11Y-1 or 11Y-2 to each other. FIG. 15 illustrates an example in which the dark fiber 11A and the dark fiber 11Y-1 are performed splice connection at the closure 50.

Further, when the dark fiber 11A and the dark fiber 11Z are performed splice connection at the closure 50, an optical fiber acquired thereby is connected to the communication station 40A and the communication station 40Z in a similar manner to the communication fiber 10AZ. Therefore, in a case of specifying the laying route of the communication fiber 10AZ, optical fiber sensing may be performed by using an optical fiber acquired by performing splice connection the dark fiber 11A and the dark fiber 11Z to each other.

As described above, according to the fourth example embodiment, even when the communication station 40A is connected to the communication stations 40Y and 40Z in a one-to-many manner, the dark fiber 11A being connected to both the communication station 40A and the closure 50 can be found. Further, the dark fibers 11Y-1 and 11Y-2 being connected to both the closure 50 and the communication station 40Y can be found. Further, the dark fiber 11Z being connected to the closure 50 and the communication station 40Z can be found. Therefore, when the dark fiber 11A and the dark fiber 11Y-1 or 11Y-2 are performed splice connection at the closure 50, an optical fiber laid on the same route as the communication fiber 10AY being connected to both the communication station 40A and the communication station 40Y may be acquired. Further, when the dark fiber 11A and the dark fiber 11Z are performed splice connection at the closure 50, an optical fiber laid on the same route as the communication fiber 10AZ being connected to both the communication station 40A and the communication station 40Z may be acquired. Therefore, by performing optical fiber sensing by using the acquired optical fiber, it is possible to specify the laying route of the communication fiber 10AY or 10AZ.

### Other Example Embodiments

In the first to fourth example embodiments described above, the communication unit 31, the sensing unit 32, and the determination unit 33 are provided in the same optical fiber sensing apparatus 30, but are not limited thereto, and may be provided to be separate from one another. For example, the communication unit 31, the sensing unit 32, and the determination unit 33 may be disposed in separate apparatuses. Further, the sensing unit 32 and the determination unit 33 may be arranged on the cloud.

### Hardware Configuration of Optical Fiber Sensing Apparatus According to Example Embodiments

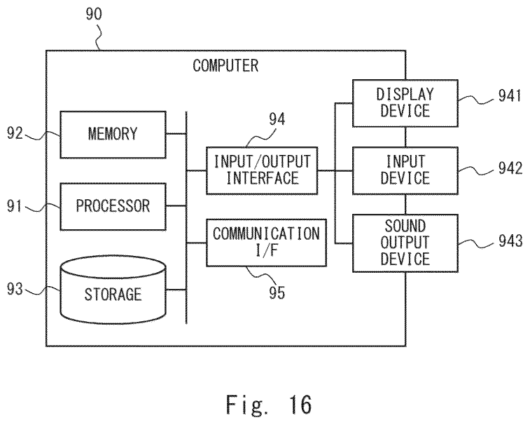

Next, an example of a hardware configuration of a computer that implements the optical fiber sensing apparatus 30 according to the above-described first to fourth example embodiments is described with reference to FIG. 16.

As illustrated in FIG. 16, a computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for transmitting and receiving data to and from one another.

The processor 91 is, for example, an arithmetic processor such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. The storage 93 may be a memory such as a RAM or a ROM.

The storage 93 stores a program for implementing the functions of the constituent elements of the optical fiber sensing apparatus 30. The processor 91 implements the functions of the constituent elements of the optical fiber sensing apparatus 30 by executing these programs. Herein, the processor 91 may read and execute the programs from the memory 92, or may execute the programs without reading them from the memory 92. The memory 92 and the storage 93 also serve to store information and data held by the constituent elements of the optical fiber sensing apparatus 30.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display device 941, an input device 942, a sound output device 943, and the like. The display device 941 is a device, such as a liquid crystal display (LCD), a cathode ray tube (CRT) display, or a monitor, that displays a screen according to drawing data processed by the processor 91. The input device 942 is a device that receives an operation input from an operator, and is, for example, a keyboard, a mouse, a touch sensor, or the like. The display device 941 and the input device 942 may be integrated and implemented as a touch panel. The sound output device 943 is a device, such as a speaker, that outputs sound according to the sound data processed by the processor 91.

The communication interface 95 transmits and receives data to and from an external device. For example, the communication interface 95 communicates with an external device via a wired communication path or a wireless communication path.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure.

For example, some or all of the above-described example embodiments may be used in combination with each other.

In addition, some or all of the above-described example embodiments may be described as follows, but the present invention is not limited thereto.

### Supplementary Note 1

An optical fiber sensing system including:
an optical fiber cable configured to contain a first optical fiber connected to a first point and a second point, and also contain a second optical fiber;
at least one memory configured to store an instruction group; and
at least one processor configured to execute the instruction group in such a way as to
   control a communication unit, to which the first optical fiber or the second optical fiber is connected, in such a way as to transmit pulsed light to the connected first optical fiber or second optical fiber and also receive an optical signal from the connected first optical fiber or second optical fiber,
   perform, in a state where the first optical fiber is connected to the communication unit at the first point side, first optical fiber sensing for sensing vibration applied to the optical fiber cable at the second point side, based on an optical signal received from the first optical fiber, and also perform, in a state where the second optical fiber is connected to the communication unit at the first point side, second optical fiber sensing for sensing the vibration applied to the optical fiber cable at the second point side, based on an optical signal received from the second optical fiber, and
   determine whether the second optical fiber is connected to the first point and the second point, based on a result of the first optical fiber sensing and a result of the second optical fiber sensing.

### Supplementary Note 2

The optical fiber sensing system according to supplementary note 1, wherein
the at least one processor is configured to execute the instruction group in such a way as to
   sense, in the first optical fiber sensing, the vibration applied to the optical fiber cable at the second point side, and when the vibration has been sensed, specify a distance on the first optical fiber from a location of the communication unit to a location where the vibration is generated,
   sense, in the second optical fiber sensing, the vibration applied to the optical fiber cable at the second point side, and when the vibration has been sensed, specify a distance on the second optical fiber from a location of the communication unit to a location where the vibration is generated,
   calculate, when the vibration has been sensed in the first optical fiber sensing and the second optical fiber sensing, a difference between a distance on the first optical fiber specified by the first optical fiber sensing and a distance on the second optical fiber specified by the second optical fiber sensing, and
   determine whether the second optical fiber is connected to the first point and the second point, based on the difference.

### Supplementary Note 3

The optical fiber sensing system according to supplementary note 2, wherein the at least one processor is configured to execute the instruction group in such a way as to determine that, when the vibration has been sensed in the first optical fiber sensing and the second optical fiber sensing, and the difference is within a predetermined range, the second optical fiber is connected to the first point and the second point.

### Supplementary Note 4

The optical fiber sensing system according to supplementary note 2, wherein the at least one processor is configured to execute the instruction group in such a way as to determine that, when the vibration cannot be sensed in the second optical fiber sensing, the second optical fiber is disconnected between the first point and the second point.

### Supplementary Note 5

The optical fiber sensing system according to supplementary note 1, wherein the first optical fiber is a communication fiber being used in a communication line.

### Supplementary note 6

An optical fiber sensing apparatus including:
at least one memory configured to store an instruction group; and
at least one processor configured to execute the instruction group in such a way as to
   control a communication unit, to which a first optical fiber connected to a first point and a second point, or a second optical fiber contained in the same optical fiber cable as the first optical fiber is connected, in such a way as to transmit pulsed light to the connected first optical fiber or second optical fiber and also receive an optical signal from the connected first optical fiber or second optical fiber,
   perform, in a state where the first optical fiber is connected to the communication unit at the first point side, first optical fiber sensing for sensing vibration applied to the optical fiber cable at the second point side, based on an optical signal received from the first optical fiber, and also perform, in a state where the second optical fiber is connected to the communication unit at the first point side, second optical fiber sensing for sensing the vibration applied to the optical fiber cable at the second point side, based on an optical signal received from the second optical fiber, and
   determine whether the second optical fiber is connected to the first point and the second point, based on a result of the first optical fiber sensing and a result of the second optical fiber sensing.

### Supplementary Note 7

The optical fiber sensing apparatus according to supplementary note 6, wherein
the at least one processor is configured to execute the instruction group in such a way as to
   sense, in the first optical fiber sensing, the vibration applied to the optical fiber cable at the second point side, and when the vibration has been sensed, specify a distance on the first optical fiber from a location of the communication unit to a location where the vibration is generated,
   sense, in the second optical fiber sensing, the vibration applied to the optical fiber cable at the second point side, and when the vibration has been sensed, specify a distance on the second optical fiber from a location of the communication unit to a location where the vibration is generated,
   calculate, when the vibration has been sensed in the first optical fiber sensing and the second optical fiber sensing, a difference between a distance on the first optical fiber specified by the first optical fiber sensing and a distance on the second optical fiber specified by the second optical fiber sensing, and
   determine whether the second optical fiber is connected to the first point and the second point, based on the difference.

### Supplementary Note 8

The optical fiber sensing apparatus according to supplementary note 7, wherein the at least one processor is configured to execute the instruction group in such a way as to determine that, when the vibration has been sensed in the first optical fiber sensing and the second optical fiber sensing, and the difference is within a predetermined range, the second optical fiber is connected to the first point and the second point.

### Supplementary Note 9

The optical fiber sensing apparatus according to supplementary note 7, wherein the at least one processor is configured to execute the instruction group in such a way as to determine that, when the vibration cannot be sensed in the second optical fiber sensing, the second optical fiber is disconnected between the first point and the second point.

### Supplementary Note 10

The optical fiber sensing apparatus according to supplementary note 6, wherein the first optical fiber is a communication fiber being used in a communication line.

### Supplementary Note 11

An optical fiber sensing method performed by an optical fiber sensing apparatus, the method including:
a communication step of transmitting pulsed light to a first optical fiber connected to a first point and a second point, or to a second optical fiber contained in the same optical fiber cable as the first optical fiber, and also receiving an optical signal from the first optical fiber or the second optical fiber;
a sensing step of performing, in a state where the first optical fiber is connected to the optical fiber sensing apparatus at the first point side, first optical fiber sensing for sensing vibration applied to the optical fiber cable at the second point side, based on an optical signal received from the first optical fiber, and also performing, in a state where the second optical fiber is connected to the optical fiber sensing apparatus at the first point side, second optical fiber sensing for sensing the vibration applied to the optical fiber cable at the second point side, based on an optical signal received from the second optical fiber; and
a determination step of determining whether the second optical fiber is connected to the first point and the second point, based on a result of the first optical fiber sensing and a result of the second optical fiber sensing.

### Supplementary Note 12

The optical fiber sensing method according to supplementary note 11, wherein,
in the sensing step,
   sensing, in the first optical fiber sensing, the vibration applied to the optical fiber cable at the second point side, and when the vibration has been sensed, specifying a distance on the first optical fiber from a location of the optical fiber sensing apparatus to a location where the vibration is generated,
   sensing, in the second optical fiber sensing, the vibration applied to the optical fiber cable at the second point side, and when the vibration has been sensed, specifying a distance on the second optical fiber from a location of the optical fiber sensing apparatus to a location where the vibration is generated, and
in the determination step,
   calculating, when the vibration has been sensed in the first optical fiber sensing and the second optical fiber sensing, a difference between a distance on the first optical fiber specified by the first optical fiber sensing and a distance on the second optical fiber specified by the second optical fiber sensing, and
   determining whether the second optical fiber is connected to the first point and the second point, based on the difference.

### Supplementary Note 13

The optical fiber sensing method according to supplementary note 12, wherein, in the determination step, when the vibration has been sensed in the first optical fiber sensing and the second optical fiber sensing, and the difference is within a predetermined range, determining that the second optical fiber is connected to the first point and the second point.

### Supplementary Note 14

The optical fiber sensing method according to supplementary note 12, wherein, in the determination step, when the vibration cannot be sensed in the second optical fiber sensing, determining that the second optical fiber is disconnected between the first point and the second point.

### Supplementary Note 15

The optical fiber sensing method according to supplementary note 11, wherein the first optical fiber is a communication fiber being used in a communication line.

What is claimed is:

1. An optical fiber sensing system comprising:
an optical fiber cable configured to contain a first optical fiber connected to a first point and a second point, and also contain a second optical fiber;
at least one memory configured to store an instruction group; and
at least one processor configured to execute the instruction group in such a way as to
control a communication unit, to which the first optical fiber or the second optical fiber is connected, in such a way as to transmit pulsed light to the connected first optical fiber or second optical fiber and also receive an optical signal from the connected first optical fiber or second optical fiber,
perform, in a state where the first optical fiber is connected to the communication unit at the first point side, first optical fiber sensing for sensing vibration applied to the optical fiber cable at the second point side, based on an optical signal received from the first optical fiber, and also perform, in a state where the second optical fiber is connected to the communication unit at the first point side, second optical fiber sensing for sensing the vibration applied to the optical fiber cable at the second point side, based on an optical signal received from the second optical fiber, and
determine whether the second optical fiber is connected to the first point and the second point, based on a result of the first optical fiber sensing and a result of the second optical fiber sensing.

2. The optical fiber sensing system according to claim 1, wherein
the at least one processor is configured to execute the instruction group in such a way as to
sense, in the first optical fiber sensing, the vibration applied to the optical fiber cable at the second point side, and when the vibration has been sensed, specify a distance on the first optical fiber from a location of the communication unit to a location where the vibration is generated,
sense, in the second optical fiber sensing, the vibration applied to the optical fiber cable at the second point side, and when the vibration has been sensed, specify a distance on the second optical fiber from a location of the communication unit to a location where the vibration is generated,
calculate, when the vibration has been sensed in the first optical fiber sensing and the second optical fiber sensing, a difference between a distance on the first optical fiber specified by the first optical fiber sensing and a distance on the second optical fiber specified by the second optical fiber sensing, and
determine whether the second optical fiber is connected to the first point and the second point, based on the difference.

3. The optical fiber sensing system according to claim 2, wherein the at least one processor is configured to execute the instruction group in such a way as to determine that, when the vibration has been sensed in the first optical fiber sensing and the second optical fiber sensing, and the difference is within a predetermined range, the second optical fiber is connected to the first point and the second point.

4. The optical fiber sensing system according to claim 2, wherein the at least one processor is configured to execute the instruction group in such a way as to determine that, when the vibration cannot be sensed in the second optical fiber sensing, the second optical fiber is disconnected between the first point and the second point.

5. The optical fiber sensing system according to claim 1, wherein the first optical fiber is a communication fiber being used in a communication line.

6. An optical fiber sensing apparatus comprising:
at least one memory configured to store an instruction group; and
at least one processor configured to execute the instruction group in such a way as to
control a communication unit, to which a first optical fiber connected to a first point and a second point, or a second optical fiber contained in the same optical fiber cable as the first optical fiber is connected, in such a way as to transmit pulsed light to the connected first optical fiber or second optical fiber and also receive an optical signal from the connected first optical fiber or second optical fiber,
perform, in a state where the first optical fiber is connected to the communication unit at the first point side, first optical fiber sensing for sensing vibration applied to the optical fiber cable at the second point side, based on an optical signal received from the first optical fiber, and also perform, in a state where the second optical fiber is connected to the communication unit at the first point side, second optical fiber sensing for sensing the vibration applied to the optical fiber cable at the second point side, based on an optical signal received from the second optical fiber, and
determine whether the second optical fiber is connected to the first point and the second point, based on a result of the first optical fiber sensing and a result of the second optical fiber sensing.

7. The optical fiber sensing apparatus according to claim 6, wherein
the at least one processor is configured to execute the instruction group in such a way as to
sense, in the first optical fiber sensing, the vibration applied to the optical fiber cable at the second point side, and when the vibration has been sensed, specify a distance on the first optical fiber from a location of the communication unit to a location where the vibration is generated,
sense, in the second optical fiber sensing, the vibration applied to the optical fiber cable at the second point side, and when the vibration has been sensed, specify a distance on the second optical fiber from a location of the communication unit to a location where the vibration is generated,
calculate, when the vibration has been sensed in the first optical fiber sensing and the second optical fiber sensing, a difference between a distance on the first optical fiber specified by the first optical fiber sensing and a distance on the second optical fiber specified by the second optical fiber sensing, and
determine whether the second optical fiber is connected to the first point and the second point, based on the difference.

8. The optical fiber sensing apparatus according to claim 7, wherein the at least one processor is configured to execute the instruction group in such a way as to determine that, when the vibration has been sensed in the first optical fiber sensing and the second optical fiber sensing, and the difference is within a predetermined range, the second optical fiber is connected to the first point and the second point.

9. The optical fiber sensing apparatus according to claim 7, wherein the at least one processor is configured to execute the instruction group in such a way as to determine that, when the vibration cannot be sensed in the second optical fiber sensing, the second optical fiber is disconnected between the first point and the second point.

10. The optical fiber sensing apparatus according to claim 6, wherein the first optical fiber is a communication fiber being used in a communication line.

11. An optical fiber sensing method performed by an optical fiber sensing apparatus, the method comprising:
a communication step of transmitting pulsed light to a first optical fiber connected to a first point and a second point, or to a second optical fiber contained in the same optical fiber cable as the first optical fiber, and also receiving an optical signal from the first optical fiber or the second optical fiber;
a sensing step of performing, in a state where the first optical fiber is connected to the optical fiber sensing apparatus at the first point side, first optical fiber sensing for sensing vibration applied to the optical fiber cable at the second point side, based on an optical signal received from the first optical fiber, and also performing, in a state where the second optical fiber is connected to the optical fiber sensing apparatus at the first point side, second optical fiber sensing for sensing the vibration applied to the optical fiber cable at the second point side, based on an optical signal received from the second optical fiber; and
a determination step of determining whether the second optical fiber is connected to the first point and the second point, based on a result of the first optical fiber sensing and a result of the second optical fiber sensing.

12. The optical fiber sensing method according to claim 11, wherein,
in the sensing step,
sensing, in the first optical fiber sensing, the vibration applied to the optical fiber cable at the second point side, and when the vibration has been sensed, specifying a distance on the first optical fiber from a location of the optical fiber sensing apparatus to a location where the vibration is generated,
sensing, in the second optical fiber sensing, the vibration applied to the optical fiber cable at the second point side, and when the vibration has been sensed, specifying a distance on the second optical fiber from a location of the optical fiber sensing apparatus to a location where the vibration is generated, and
in the determination step,
calculating, when the vibration has been sensed in the first optical fiber sensing and the second optical fiber sensing, a difference between a distance on the first optical fiber specified by the first optical fiber sensing and a distance on the second optical fiber specified by the second optical fiber sensing, and
determining whether the second optical fiber is connected to the first point and the second point, based on the difference.

13. The optical fiber sensing method according to claim 12, wherein, in the determination step, when the vibration has been sensed in the first optical fiber sensing and the second optical fiber sensing, and the difference is within a predetermined range, determining that the second optical fiber is connected to the first point and the second point.

14. The optical fiber sensing method according to claim 12, wherein, in the determination step, when the vibration cannot be sensed in the second optical fiber sensing, determining that the second optical fiber is disconnected between the first point and the second point.

15. The optical fiber sensing method according to claim 11, wherein the first optical fiber is a communication fiber being used in a communication line.
